(19) United States
(12) Patent Application Publication
(10) Pub. No.: US 2015/0058032 A1
(43) Pub. Date: Feb. 26, 2015

(54) System for sharing data within an electrophysiology lab

(71) Applicant: St. Jude Medical, Atrial Fibrillation Division, Inc., St. Paul, MN (US)

(72) Inventors: Charles Bryan Byrd, Oakdale, MN (US); Jeffrey L. Burrell, Coon Rapids, MN (US); Stephan P. Miller, Vadnais Heights, MN (US); Anthony P. Scinicariello, Maple Grove, MN (US)

(21) Appl. No.: 14/378,566

(22) PCT Filed: Dec. 28, 2012
(86) PCT No.: PCT/US12/72040

§ 371 Date: Aug. 13, 2014

Related U.S. Application Data
(60) Provisional application No. 61/581,806, filed on Dec. 30, 2011.

(51) Int. Cl. G06F 19/00

(52) U.S. Cl. CPC G06F 19/324
USPC 705/2

(57) ABSTRACT

A system for sharing data in an electrophysiology (EP) lab including a plurality of systems comprises a data server configured to be electrically coupled with a memory device and with the plurality of systems, the memory device being coupled with a medical device. The data server is configured to receive device data stored on the memory device, to transmit the received device data to at least one of the plurality of systems, to receive device use data from at least one of the plurality of systems, and to transmit the device use data to the memory device. The systems may comprise one or more of a mapping and navigation system, an ablation system, and an EP recording system.

### CROSS-REFERENCE TO RELATED APPLICATION

This application claims the benefit of U.S. provisional application No. 61/581,806, filed Dec. 30, 2011, which is hereby incorporated by reference in its entirety as though fully set forth herein.

### BACKGROUND OF THE INVENTION

a. Field of the Invention

The instant disclosure relates generally to electrophysiology lab integration, and more specifically to the integration of memory devices, such as, for example and without limitation, electrically erasable programmable read-only memory (EEPROM) devices, with various systems or components in an electrophysiology laboratory.

b. Background Art

It is known to provide an electrophysiology laboratory (EP lab) in a medical facility. Such a lab may have use of a wide variety of diagnostic and therapeutic equipment useful in rendering medical service to a patient, such as imaging systems (e.g., fluoroscopy, intracardiac echocardiography, etc.), an electro-anatomic visualization, mapping and navigation system, ablation energy sources (e.g., radio frequency (RF) ablation generator), a recording system (e.g., for ECG, cardiac signals, etc.), a cardiac stimulator and the like.

In EP labs and other medical device systems, it is beneficial for the visualization, mapping, navigation, recording, ablation, and other like systems to know specific information about the particular medical devices being used. For example, a mapping system can more accurately render an anatomical geometry if the mapping system knows the exact locations of electrodes on the medical device (e.g., catheter) used to collect data points, which may vary greatly across different catheter models and may further vary in the manufacturing process from model specifications. Such medical device information may be stored on a memory device, such as an EEPROM coupled with the medical device. Data, such as information about the number of uses of the medical device and information about a procedure in which the medical device was used, can also be written to the memory device.

Although memory devices are known to be coupled with medical devices to store various types of data, the use of that data is generally limited to the single system (i.e., mapping and navigation system, ablation system, or recording system, for example) to which the device is connected. There is therefore a need to improve the integration of memory devices, such as, for example and without limitation, EEPROMs, with multiple systems, components, and/or medical devices in an EP lab.

### BRIEF SUMMARY OF THE INVENTION

It is advantageous in an EP lab system to share data from a memory device coupled to a medical device with a plurality of systems. Such a system for sharing comprises a data server configured to be electrically coupled with a memory device and with the plurality of systems. The data server is configured to receive device data stored on the memory device, to transmit the received device data to at least one of the plurality of systems, to receive device use data from at least one of the plurality of systems, and to transmit the device use data to the memory device. In an embodiment, the memory device comprises one of an electrically erasable programmable read-only memory and a radio frequency identification chip. In an embodiment, the data server is configured to be electrically coupled with a plurality of memory devices, each of the plurality of memory devices coupled with a respective medical device, and the data server is configured to transmit the device use data to two or more of the plurality of memory devices.

The device data may comprise a number of different types of data. In an embodiment, the device data comprises device characteristic data. The device characteristic data may comprise data relating to at least one of the electrode spacing of electrodes of the medical device, the length of at least one electrode of the medical device, the number of electrodes of the medical device, the diameter of the electrodes of the medical device, the curve shape of the medical device, the manufacturer of the medical device, the model of the medical device, the brand of the medical device, and the type of the medical device. In another embodiment, the device data comprises device use data. The device use data may comprise data relating to at least one of a usage count of the medical device, a usage duration of the medical device, and a usage timestamp of the medical device.

The system may include various layers of encryption. In an embodiment, the data server is further configured to transmit data in an encrypted format. In the same or another embodiment, the memory device is configured to store data in an encrypted format. In the same or another embodiment, the data server is further configured to decrypt data received from said memory device.

In a further embodiment, the sharing system includes the data server and an apparatus configured to be electrically coupled with a plurality of medical devices, to receive device data from a plurality of memory devices respectively coupled to the plurality of medical devices, to receive sensor data from a plurality of sensors coupled to the medical devices, and to route the device data and the sensor data. In the embodiment, the data server may be configured to receive device data respective of at least one of the memory devices from the apparatus and to transmit the received device data to one or more of the plurality of systems.

In an embodiment, the apparatus is further configured to be electrically coupled with an ablation system and to connect the ablation system to at least one of the medical devices for ablation energy to be provided from the ablation system to the at least one medical device. The apparatus may be further configured to route device data respective of at least one of the plurality of memory devices, the at least one memory device coupled to the at least one medical device, to the ablation system.

In a further embodiment, the sharing system includes a medical device, a memory device coupled with the medical device, a junction box, and the data server. In the embodiment, the junction box is configured to be coupled with the medical device, to receive device data stored on the memory device, to route the device data to the data server, and to route device use data to the memory device. In the embodiment, the data server is configured to receive device data from the junction box, to transmit the device data to one or more of the plurality of systems, to receive device use data from one or more of the plurality of systems, and to transmit the device use data to the junction box.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a schematic and block diagram view of an electrophysiology lab system.

FIG. 2 is a schematic and block diagram view of an electrophysiology lab system, illustrating an exemplary distribution of components in a lab environment.

FIG. 3 is an isometric view of an exemplary computer-readable memory device for coupling with a medical device.

FIGS. 4-8 are diagrammatic views of several exemplary medical device connectors that may be used to transmit data to and from a memory device coupled with a medical device.

FIG. 9A is an isometric view of a receiving port that may be used to transmit data to and from a memory device coupled with a medical device.

FIG. 9B is an isometric view of a medical device connector that may be coupled with the receiving port FIG. 9A.

### DETAILED DESCRIPTION OF THE INVENTION

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

It will be appreciated that the terms “proximal” and “distal” may be used throughout the specification with reference to a clinician manipulating one end of an instrument used to treat a patient. The term “proximal” refers to the portion of the instrument closest to the clinician and the term “distal” refers to the portion located furthest from the clinician. It will be further appreciated that for conciseness and clarity, spatial terms such as “vertical,” “horizontal,” “up,” and “down” may be used herein with respect to the illustrated embodiments. However, surgical instruments may be used in many orientations and positions, and these terms are not intended to be limiting and absolute.

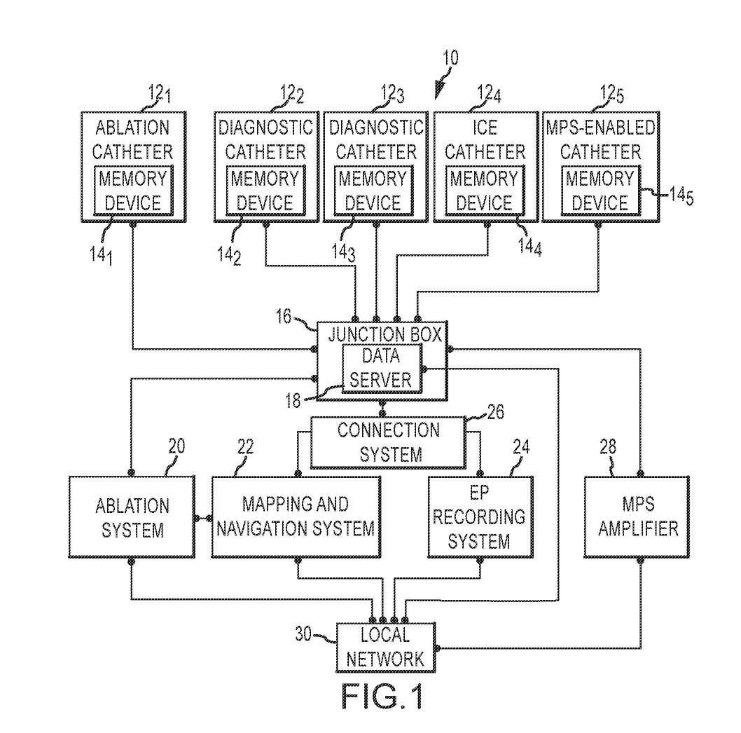

Referring now to the drawings wherein like reference numerals indicate similar components in the various views, FIG. 1 is a block diagram view of an electrophysiology (EP) lab system 10. In an exemplary embodiment, the system 10 includes one or more elongate medical devices 12, one or more memory devices 14, a junction box 16, a data server 18, and multiple systems such as, for example, an ablation system 20, a mapping and navigation system 22, an EP recording system 24, a connection system 26, and a magnetic field-based mapping and positioning system (MPS) including an MPS amplifier 28. The MPS may also include other components that are not shown. The system 10 may further include a local network 30, which may also be coupled to a wide-area network. Though not shown, the system may also include one or more systems capable of providing images of the patient's body, such as a fluoroscopy or ultrasound system. It will be appreciated that while in an exemplary embodiment the system 10 includes each of the components identified above, in other exemplary embodiments the system 10 may comprise more or fewer than all of those components identified above. Accordingly, embodiments of the system 10 having more or fewer than those components identified above remain within the spirit and scope of the present invention.

The system 10 may be used to perform many different diagnostic and therapeutic procedures on a patient, and thus many different types of elongate medical devices 12 are provided in the system 10. For example, an ablation catheter 12₁ is provided for the performance of ablation therapy to, e.g., correct conditions such as atrial arrhythmia, including for example, ectopic atrial tachycardia, atrial fibrillation, and atrial flutter. One or more diagnostic catheters, such as diagnostic catheters 12₂, 12₃ may include one or more sensors (e.g., electrodes, magnetic sensors, and the like) for use in, for example only, the collection of EP data or creating a model or map of patient anatomy. An intracardiac echocardiography (ICE) catheter 12₄ may be provided for the collection of real-time or recordable images of patient anatomy, such as the interior of the patient's heart. The system 10 may further include an ICE imaging console for, e.g., processing and viewing data from the ICE catheter 12₄.

The elongate medical devices 12 may be equipped with sensors configured to function with one or more positioning and navigation systems. For example, the MPS-enabled catheter 12₅ includes at least one MPS sensor configured to respond to an applied magnetic field such that the position of the sensor in the field may be determined by an MPS (not shown). The elongate medical devices 12 may also include sensors for use with an electrical impedance-based positioning system, or separate sensors for both a magnetic field-based system and an electrical impedance-based system.

It should be understood that the elongate medical devices 12 shown in FIG. 1 are exemplary in nature only. More or fewer elongate medical devices 12 may be used with the system 10, and in different combinations. Furthermore, the system 10 may include elongate medical devices not shown in FIG. 1, such as, for example, sheaths and guidewires, and other types of medical devices such as, for example, electrocardiogram (ECG) patches and/or electrical patches for use with an impedance-based positioning system.

Each of the elongate medical devices 12 includes (i.e., is coupled with) a respective memory device 14 for the storage of data related to the medical device 12, such as the configuration of the medical device 12, and data related to procedures in which the medical device 12 has been used. As used herein, data that may be stored on a memory device 14 is referred to as “device data.” Certain device configuration data may be stored in a memory device 14 for all types of medical devices (e.g., ablation catheters, diagnostic catheters). For example, a device description, diameter (i.e., French size), manufacturer, model, brand, type of device, maximum use time of the device, expiration date of the device, and a unique device identifier (such as a serial number) may all be stored for any given device. Other data that may be stored may relate to positioning sensors incorporated into the medical device 12. For example, the type, locations, spacing, size, and number of sensors may be stored, as well as information particular to an individual sensor. Electrode-equipped mapping catheters may have information stored related to the electrodes, such as electrode spacing, electrode size, electrode impedance, and number of electrodes. Depending on the construction of the medical device 12, certain physical characteristics may be stored, such as extension length, tip profile, length, sweep length, curve shape (e.g., Cournand) outer diameter, inner diameter, fulcrum, and maximum tension.

In an exemplary embodiment, the memory device 14₁ coupled with the ablation catheter 12₁ may have many additional types of data stored (i.e., in addition to those types of data mentioned above), such as maximum power, maximum temperature, maximum and minimum impedance, default power, default temperature, default impedance, temperature response, power ramp rate, contact or proximity sensing capabilities of the device, whether the ablation tip is irrigated, pump low flow rate (i.e., flow of irrigation fluid), and pump high flow rate. The maximum usable life of ablation components in the device 12 may also be stored.

Device use data—i.e., data related to the use of a medical device 12 or a procedure in which the medical device 12 is used—may also be stored on the memory device 14 associated with that medical device 12. For example, time stamps for various events (creation of the device, first use of the device, subsequent uses of the device, etc.) may be stored, along with the number of times and amount of time the device has been used.

Device data may be entered to a memory device 14 during the manufacturing process of the medical device 12 to which it is coupled. In an embodiment, device characteristic data, such as electrode spacing and number of electrodes, may be determined manually or automatically as a medical device 12 is manufactured and stored on the associated memory device 14 (again, manually or as part of an automated process) as part of the manufacturing process. In an embodiment, device characteristic data may be determined and stored on a memory device 14 after manufacturing has been completed.

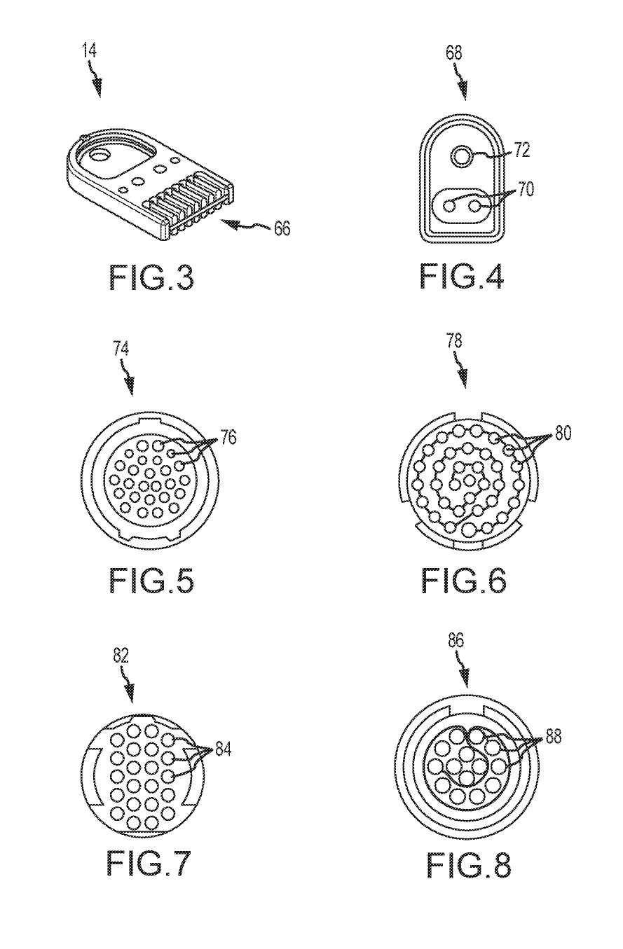

The memory devices 14 may comprise electrically-erasable programmable read-only memory (EEPROM) chips, wireless (e.g., RFID) chips, or any other appropriate form of memory. Each memory device 14 may be removably coupled with a medical device 12 or may be a permanent component of the medical device 12. An exemplary embodiment of a memory device 14 that may be coupled with a medical device 12 is shown in FIG. 3.

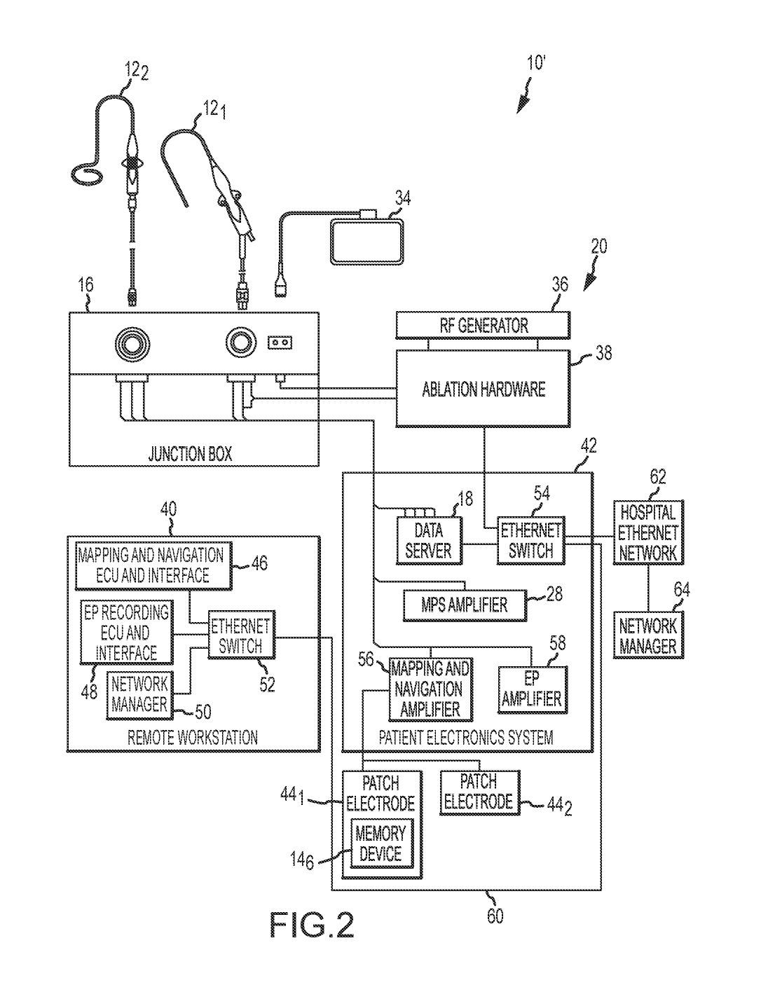

As illustrated in FIGS. 1 and 2, each of the elongate medical devices 12 is electrically connected to the junction box 16, which acts as a common interface for medical devices 12 and other components of the system 10. The junction box 16 includes multiple ports and connectors for connecting to the various components in the system 10 and interface hardware for routing, separating, and/or grouping transmission pathways as necessary. The junction box 16 may receive, separate, group, and route data and signals including, for example only, device data, position sensor data (i.e., from sensors for use with a mapping and navigation system) and data from other electrodes and sensors. For example, the junction box 16 may receive MPS signals from the MPS-enabled catheter 12₅ and provide the MPS signals to the MPS amplifier 28 which is electrically connected to, and configured for communication with, the junction box 16. The junction box 16 may also connect the ablation catheter 12₁ with the ablation system 20 so that ablation energy may be provided to the ablation catheter 12₁ for delivery to a target site. The ports and connectors on the junction box 16 may be configured to connect with many different medical devices currently known and hereafter introduced. For example, the ports and connectors in the junction box 16 may have configurations as shown in FIGS. 4-8.

As described above, the system 10 further includes a data server 18. The data server 18 is provided to read, write, and transmit device data stored on the memory devices 14. In an embodiment, the data server 18 is a component in the junction box 16, as shown in FIG. 1. However, the data server 18 may also be a physically separate component, as shown in FIG. 2, that is electrically connected to, and configured for communication with, the junction box 16. In either instance, the data server 18 acts as the central distributor of data stored on the memory devices 14. The data server 18 can identify each memory device 14, read data from each memory device 14, and write data to each memory device 14 as required by the other components in the system 10. In an embodiment, the data server 18 has exclusive read-write access to all of the memory devices 14. In another embodiment, other components of the system may have read and/or write access to one or more of the memory devices 14 in addition to or instead of the data server 18.

The data server 18 may distribute device data through direct connections to the other components of the system 10 or through a local network 30. The local network 30 may be private—i.e., accessible only by components of the system 10 or with permission from one of the components of the system 10. The local network 30 may be used to transmit many types of data in the system, such as device data and sensor data, as described in greater detail in conjunction with FIG. 2. The data server 18 may distribute data according to a propriety data protocol or according to any one of a number of data protocols known in the art.

Various layers of encryption may be applied to device data in the system 10 to protect procedure-specific information that may be related to specific patients as well as to protect propriety device information. For example, the device data stored on a memory device 14 may be encrypted, the data server 18 or a portion of the local network 30 may apply encryption as data is transmitted, and the systems within the system 10 may store data read from the memory devices 14 in an encrypted format. In an embodiment, the data server 18 may be configured to receive device data in an encrypted format from the memory devices 14 and decrypt that data and to receive unencrypted device use data from the various systems in the system 10 and encrypt that device use data before transmission to one or more of the memory devices 14. The data may be encrypted using one or more of any number of encryption techniques well known in the art.

The ablation system 20 provides a number of functions that contribute to the performance of ablation therapy with the ablation catheter 12₁. The ablation system 20 may include a generator to generate, control, and deliver ablation energy (shown in FIG. 2), and hardware configured to perform a number of other functions, such as sensing contact between tissue and an ablation electrode, and monitoring the temperature and impedance at an ablation site (also shown in FIG. 2). Such contact may be sensed using methods and/or devices described in U.S. Patent Application Publication No. 2009/0163904, hereby incorporated by reference in its entirety as though fully set forth herein.

The ablation system 20 may receive device data from the memory device 14₁ via the data server 18 for a number of purposes. For example, during an initial device registration process, the ablation system 20 may use data from the memory device 14₁ to determine if the ablation catheter 12₁ is proper for the intended procedure. For example, data on the memory device 14₁ may be used by the ablation system 20 to ensure that the ablation catheter 12₁ has not been used for more procedures or for a longer duration than ablation catheter 12₁ is designed to be used, that the ablation catheter 12₁ contains features necessary or desirable for the procedure (e.g., irrigation pathways, contact or proximity sensing hardware), and the like. The ablation system 20 may also use data from the memory device 14₁ to determine features and characteristics of the ablation catheter 12₁ that may affect the processing of data or provision of ablation energy by the ablation system 20, such as the actual impedance of ablation elements within the ablation catheter 12₁.

The ablation system 20 may receive device data from the data server 18, as shown in FIG. 1. In another embodiment, such as shown in FIG. 2, device data from the memory device 14₁ coupled with the ablation catheter 12₁ may be transmitted directly from the junction box 16 to the ablation system 20. In such an embodiment, both the ablation system 20 and the data server 18 may have read/write access to the memory device 14₁ (i.e., the junction box 16 transmits the device data to both the ablation system 20 and the data server 18), or the ablation system 20 may have exclusive read/write access to the memory device 14₁. If the ablation system 20 has exclusive read/write access, though, the ablation system 20 may share device data from the memory device 14₁ with the other components of the system via direct connections or via the local network 30.

The mapping and navigation system 22 is configured to provide many advanced features, such as visualization, mapping, navigation support and positioning (i.e., determine a position and orientation (P&O) of a sensor-equipped medical device, for example, a P&O of a distal tip portion of one of more of the catheters 12). The mapping and navigation system 22 may be, for example, an ENSITE VELOCITY™ system running a version of NAVX™ software available from St. Jude Medical, Inc., of St. Paul, Minn. and as also seen generally by reference to U.S. Pat. No. 7,263,397, hereby incorporated by reference in its entirety as though fully set forth herein. The mapping and navigation system 22 can comprise conventional apparatus known in the art, for example, the EnSite™ Velocity™ system described above or other known technologies for locating/navigating a catheter in space (and for visualization), including, for example, the Carto™ visualization and location system of Biosense Webster, Inc., the Aurora™ system of Northern Digital Inc., a magnetic field based localization system such as one based on the MediGuide™ technology from St. Jude Medical, Inc. (e.g., as exemplified by U.S. Pat. Nos. 7,386,339; 7,197,354; and 6,233,476; all of which are hereby incorporated by reference in their entireties as though fully set forth herein) or a hybrid magnetic field-impedance based system, such as the system described in U.S. patent application Ser. No. 13/231,284, which is hereby incorporated by reference in its entirety as though fully set forth herein, or the Carto™ 3 visualization and location system of Biosense Webster, Inc. Some of the localization, navigation and/or visualization systems can involve providing a sensor for producing signals indicative of catheter location and/or orientation information, and can include, for example, one or more electrodes in the case of an impedance-based localization system such as an EnSite™ Velocity™ system running NavX™ software, which electrodes can already exist in some instances, or alternatively, one or more coils (i.e., wire windings) configured to detect one or more characteristics of a low-strength magnetic field, for example, in the case of a magnetic-field based localization system such as one based on the MediGuide™ technology described above.

The mapping and navigation system 22 may use device data stored on one or more of the memory devices 14 to, e.g., build and display more accurate anatomical models, more accurately display the position of one or more sensors or medical devices, and more accurately display the location of collected EP data. For example, the mapping and navigation system 20 may use device data from the memory device 14₂ to determine the exact locations of electrodes on the diagnostic catheter 12₂ so that data from those electrodes can be more accurately processed and displayed. Additionally, the mapping and navigation system 22 may cause the data server 18 to write data to the memory devices 14₂, 14₃ to increment the usage count of the diagnostic catheters 12₂, 12₃, increase the usage time of the diagnostic catheters 12₂, 12₃, or to store other data related to the use of the diagnostic catheters 12₂, 12₃.

The EP recording system 24 is provided for the collection, storage, retrieval, and analysis of electrophysiology (EP) data, such as data from electrocardiogram (ECG) patches (not shown) and mapping of EP activity on a model of a heart. In an embodiment, the EP recording system 24 may be an EP-WorkMate™ EP Lab Recording System available from St. Jude Medical, Inc. of St. Paul, Minn., or another EP recording system known in the art.

The EP recording system 24 and the mapping and navigation system 22 are electrically connected through the connection system 26. The connection system is configured to facilitate the sharing of signals and data between the EP recording system 24 and the mapping and navigation system 22 so that ECG signals and other EP data may easily be shared with the mapping and navigation system 22 for the creation and display of maps and models and integrated display of EP data, maps, and models. In an embodiment, the connection system may be the RecordConnect module or system commercially available from St. Jude Medical, Inc. of St. Paul, Minn.

The MPS amplifier 28 is provided to convert the analog signals from MPS sensors, such as one or more sensors in the MPS-enabled catheter 12₅, into a digital form. The digital signals can then be used by an MPS (not shown) to determine position and orientation data for the MPS sensors. The MPS signals may also be used by a hybrid electrical impedance-based and magnetic field-based system, such as described in U.S. patent application Ser. No. 13/231,284, incorporated above, or the Carto™ 3 visualization and location system of Biosense Webster, Inc. Data stored on the memory device 14₅ may be used by one of the above-described systems to, for example, determine the exact location of the MPS sensors in the MPS-enabled catheter 12₅ to more accurately determine and display the locations of those sensors.

In operation, the data server 18 may serve as the central distribution point for device data. The data server 18 may read or receive device data from the memory devices 14 and transmit that device data to the other components and systems in the system 10. Device data needed by the mapping and navigation system 22, the ablation system 20, the recording system 24, and other systems and components of the system 10 may be obtained by querying the data server 18, which can read the needed data from the relevant memory device 14 and transmit the data as necessary. Similarly, the data server 18 may receive device use data from any of the components and systems in the system 10 and transmit or write that data to one or more of the memory devices 14. Thus, the mapping and navigation system 22, the ablation system 20, the recording system 24, and other systems and components of the system 10 may write data to any of the memory devices 14 through the data server 18. For example, the ablation system 20 may write the amount of ablation time in a particular procedure to each of the memory devices 14₁, 14₂, 14₃, 14₄, 14₅ through the data server 18. Thus, multiple systems and components in the EP lab system 10 may be provided with coordinated access to and control of device data on multiple memory devices 14 through functional communication with only a single component: the data server 18.

FIG. 2 is a schematic and block diagram view of another exemplary embodiment of an EP lab system 10′. The system 10′ includes a diagnostic catheter 12₂, an ablation catheter 12₁, an ablation dispersive patch 34, a junction box 16, an ablation system 20 including an RF generator 36 and ablation hardware 38, a remote workstation 40, a patient electronics system 42, and body patch electrodes 44. The remote workstation 40 includes a mapping and navigation electronic control unit (ECU) and interface 46, an EP recording ECU and interface 48, a network manager 50, and an ethernet switch 52. The patient electronics system 42 includes a data server 18, an ethernet switch 54, an MPS amplifier 28, a mapping and navigation amplifier 56, and an EP amplifier 58. It will be appreciated that many of the components and systems in the system 10′ are the same as or similar to components and systems in the system 10 described above. Accordingly, except as otherwise noted, those descriptions apply equally to the system 10′.

Before proceeding to a detailed description of the components of the system 10′, a general description of the layout and data flow of the system 10′ will first be set forth below. The ablation catheter 12₁, diagnostic catheter 12₂, dispersive patch 34, ablation system 20, and patient electronics system 42 are all electrically coupled to the junction box 16. The junction box 16 directs the flow of signals and data between those components and other systems of the system 10′. The patient electronics system 42, which may be placed near the patient bed, performs certain signal processing functions (as further described below) and transmits data to and receives data from the remote workstation 40 via a communications link 60. The remote workstation 40, which may be placed away from the patient bed, (i.e., in a separate control room), transmits and receives data via the communications link 60. In an embodiment, the communications link 60 may be a fiber optic link, though the communications link may also be a wireless link or another communications link known in the art. In addition to the communications link 60, both the remote workstation 40 and the patient electronics system 42 may receive and transmit data over the hospital local network 62 under the direction of the hospital network manager 64. It should be understood that the data flow described above is exemplary in nature only, and the system 10′ may comprise additional or different components and architectures.

As noted above, the diagnostic catheter 12₂ may be provided for one or more of a number of diagnostic functions, such as, for example only, geometry collection or EP mapping. The diagnostic catheter 12₂ is shown as a circular mapping catheter, but the diagnostic catheter 12₂ may be any other diagnostic elongate medical device known in the art, such as, for example only, a fixed or steerable diagnostic catheter.

The ablation catheter 12₁ and dispersive patch 34 are provided to apply ablation therapy to a selected location in the patient, such as in the patient's heart. An ablation signal may be driven through one or more electrodes in the ablation catheter 14₁, and the dispersive patch may act as an RF indifferent/dispersive return for the driven RF ablation signal.

The junction box 16 is provided as a common interface for multiple medical devices and apparatus within the system 10′. As noted above, the junction box 16 may receive, separate, group, and transmit data and signals including, for example only, device data, position sensor data (i.e., from sensors for use with a mapping and navigation system) and data from other electrodes and sensors. The junction box may also connect the ablation catheter 12₁ to the ablation hardware 38 and/or the RF generator 36 for ablation energy to be provided to a target site through the ablation catheter 12₁. The junction box 16 is electrically connected to one or more systems or components of the system 10′, and is configured to receive data and signals from and route data and signals to one or more of those systems or components. For example, the junction box 16 is configured to transmit the device data from the diagnostic catheter 12₂ to the data server 18 and the device data from the ablation catheter 12₁ to the ablation system 20 (and, in an embodiment, to the data server 18 as well). The junction box 16 further receives sensor and electrode data from the catheters 12₁, 12₂ and transmits the sensor and/or electrode data to the mapping and navigation amplifier 56, the EP amplifier 58, and/or the MPS amplifier 28.

Data may be transmitted to or from a memory device 14 with a higher current than sensor and electrode data. As a result, it could be dangerous to the patient to whom electrodes are connected or in whom electrodes and sensors are disposed if device data signals are transmitted through an electrode signal pathway. As a result, it is advantageous to use certain safeguards to effectively isolate the device data signal pathway from the signal pathways used for electrodes and other sensors. For example, in an embodiment, the junction box 16 (and other components in the system 10′) may be configured with high galvanic isolation between device data transmission pathways and sensor data transmission pathways so that the two pathways do not become shorted. The junction box 16 (and, again, other components in the system 10′) may also be configured to detect a short between a device data transmission pathway and an electrode or sensor signal pathway and to alter, cease, or prevent device data transmission to prevent harm to the patient. In another embodiment, device data may be transmitted to and from the memory devices 14 wirelessly, thereby minimizing or eliminating the risk.

The ablation system 20 includes an ablation energy source (shown as an RF generator 36) and ablation hardware 38. It should be understood that the invention is not restricted to RF ablation energy. Other types of ablation energy may be used, such as, for example, ultrasound or cryogenic. The RF ablation generator 36 may comprise a unit available under the model number IBI-1500T RF Cardiac Ablation Generator, available from St. Jude Medical, Inc. The ablation hardware 38 may include hardware and software for several functions such as, for example, providing ablation energy from the RF generator 36 to the ablation catheter 12₁, assessing contact between tissue and an electrode on the ablation catheter 12₁, and monitoring the temperature at an ablation site.

The mapping and navigation ECU and interface 46, the mapping and navigation amplifier 56, and the body patch electrodes 44 collectively provide mapping, visualization, and navigation functionality for the system 10′, such as the functionality embodied in the mapping and navigation system 22 shown in FIG. 1. Two patch electrodes 44₁, 44₂ are shown, but patch electrodes 44 may be placed on the body of the patient in a variety numbers and arrangements. In an embodiment, seven patch electrodes are placed on the body of the patient: two patches along the X-axis (i.e., on the left and right side of the patient's chest), two patches along the Y-axis (i.e., on the front of the patient's chest and on the patient's back), two patches along the Z-axis (i.e., on the patient's neck and thigh), and one “belly patch” that may be used as a reference electrode. Of course, other patch electrode configurations and combinations are suitable for use with the present invention, including fewer electrodes, e.g., three electrodes, more electrodes, e.g., twelve, or different physical arrangements, e.g., a linear arrangement instead of an orthogonal arrangement. The electrode patches may be excited in pairs to create electric fields. During the delivery of the excitation signal (e.g., current pulse), the voltages on the remaining (unexcited) patch electrodes may be measured with reference to the belly patch electrode. The voltage on an electrode on a medical device disposed in the patient's body (e.g., ablation catheter 12₁) may similarly be measured to determine the location of the medical device in the patient.

The mapping and navigation amplifier 56 may include hardware and software to digitize the signals from the patch electrodes 44 (and from other electrodes used for mapping and navigation functions, such as, for example, electrodes in a catheter 12) and to provide the digital signals to the mapping and navigation ECU and interface 46 for further processing. The mapping and navigation ECU and interface 46 can include one or more ECUs, displays, memory devices, and user input devices (e.g., mouse, keyboard, and other known user interfaces). The mapping and navigation ECU and interface 46 may receive and process the digitized signals from the amplifier 56, to, for example, determine the location of one or more electrodes in the patient's body, create a map or model of patient geometry, and display maps, models, and medical device representations for a user.

The patch electrode 44₁ includes a memory device 14₆ for the storage of device data, such as data related to characteristics of the set of patch electrodes 44 or data related to the use of the set of patch electrodes 44. For example, data stored on the memory device 14₆ may include a usage count, a validation timestamp, a maximum usage time, an expiration date, and a creation timestamp, as well as a device description, a manufacturer, model, brand, and unique device identifier (such as, for example only, a serial number). In an exemplary embodiment, the mapping and navigation ECU and interface 46 will validate the patch electrodes 44 to ensure that the patch electrodes 44 have not been used in more procedures than the patch electrodes 44 are designed for.

The memory device 14₆ coupled with the patch electrodes 44 can be one or more EEPROM chips, wireless (e.g., RFID) chips, or another type of computer-readable memory. A single set of patch electrodes 44 may have a single memory device 14₆ (e.g., coupled with a particular patch electrode, such as the leg patch), or multiple memory devices 14 respectively coupled with multiple patch electrodes 44. Because the patch electrodes 44 may be coupled to the mapping and navigation amplifier 56, the mapping and navigation amplifier 56 may route device data stored on the memory device 14₆ to the data server 18 for distribution to the remainder of the system 10′ as needed. In addition, the mapping and navigation amplifier 56 may write device use data to the memory device 14₆, such as incrementing the usage count at the beginning of a medical procedure.

In an embodiment, one or more of the patch electrodes 44 may be coupled directly with the junction box 16, rather than directly with the mapping and navigation amplifier 56. In such an embodiment, the junction box may route device data stored on the memory device 14₆ to the data server 18 for distribution to the remainder of the system 10′ as needed, including to the mapping and navigation amplifier 56. In addition, the data server 18 or other component of the system 10′ may write device use data to the memory device 14₆, such as incrementing the usage count at the beginning of a medical procedure, via the junction box 16.

The EP recording ECU and interface 48 and EP amplifier 58 collectively provide EP data collection and recording functionality for the system 10′. The EP amplifier 58 may include hardware and software to digitize signals received from ECG leads coupled to the body (not shown) and provide the ECG signals to the EP recording ECU and interface 48 for further processing and display. The EP recording ECU and interface 48 may include one or more ECUs, displays, memory devices, and user input devices. The EP recording ECU and interface 48 may receive and process the digitized signals from the EP amplifier 58 to, for example, display an ECG signal (either stored or currently collected) for physician review.

It should be understood that the EP recording ECU and interface 48 and the mapping and navigation ECU and interface 46 may be embodied in a single or multiple apparatus. One or more ECUs, memory devices, displays, user input devices, and other components may be shared by the EP recording ECU and interface 48 and the mapping and navigation ECU and interface 46, or the EP and the mapping and navigation components of the system 10′ may have separate components, as shown in FIG. 2.

As noted above, the system 10′ also includes the MPS amplifier 28. The MPS amplifier 28 may include hardware and software configured to digitize signals from the various components involved in a magnetic field-based mapping and navigation system, including coils used to create orthogonal magnetic fields (not shown), a reference sensor placed on the patient's chest (also not shown), and one or more sensors integrated into a medical device, such as MPS-enabled catheter 12₅. The MPS amplifier 28 may transmit the digitized signals to another component of the system 10′, such as an independent magnetic-field based mapping and navigation ECU (not shown), or to the mapping and navigation ECU and interface 46 for processing and display in conjunction with data from electrical-impedance based components of the system 10′.

As noted above with respect to the system 10, the data server 18 generally directs the reading, writing, and distribution of device data in the system 10′. Unlike the system 10 shown in FIG. 1, however, the system 10′ shown in FIG. 2 includes memory devices 14 that may be accessed by certain systems and components without the use of the data server 18. Accordingly, device data may be read from and written to different memory devices 14 by different components of the system 10′. For example, the data server 18 may have exclusive read/write access to the memory device 14₂ (shown in FIG. 1) coupled with the diagnostic catheter 12₂, both the data server 18 and the ablation hardware 38 may have read/write access to the memory device 14₁ (shown in FIG. 1) coupled with the ablation catheter 12₁, and the mapping and navigation ECU and interface 46 may have exclusive read/write access to the memory device 14₆ coupled with the body patch electrodes 44.

In an embodiment, the data server 18 may be further configured to communicate with the hospital local network 62 to send device data (such as, for example, a serial number for each memory-equipped medical device 12 and/or patch set 44 used in a procedure) to appropriate hospital systems for inventory and billing. Such information flow may be used to partially or fully automate the inventory management and/or billing related to the use of memory-equipped medical devices 12 and patch electrodes 44.

The network manager 50 may be used to facilitate network-based communication between the components on the remote workstation 40 (i.e., the mapping and navigation ECU and interface 46 and the EP recording ECU and interface 48) and the rest of the system 10′. Accordingly, the network manager 50 may be configured to receive device data transmitted over the communications link 60 and distribute the received device data to the mapping and navigation ECU and interface 46 and the EP recording ECU and interface 48. The network manager 50 may also be configured to receive device data write commands from the mapping and navigation ECU and interface 46 and the EP recording ECU and interface 48 and to transmit those commands over the communications link 60 to be executed by, for example only, the data server 18.

FIG. 3 is an isometric view of an exemplary embodiment of a memory device 14 that may be coupled with one of the medical devices in system 10 or system 10′. The memory device 14 may be a serial I²C EEPROM memory with 8 contacts (collectively designated contacts 66), such as one of the devices in the SlimLine™ IST series of serial memory tokens commercially available from Datakey Electronics, Inc. of Savage, Minn. The memory device 14 may have one of a number of storage sizes such as, for example only, storage in the range of 1 kilobyte (KB) to 256 KB. In an embodiment, the memory device 14 may be a single-wire EEPROM.

FIGS. 4-8 are diagrammatic views of exemplary connector pin layouts that may be used to transmit sensor data, device data, and other signals and data between medical devices, such as elongate medical devices 12 and body patches 44, and other components of an EP lab system, such as the system 10 or the system 10′. The exemplary connectors shown in FIGS. 4-8 may be placed on the proximal end of various medical devices, with complementary ports placed on other components in the system 10 or the system 10′, such as, for example only, the junction box 16 and/or the mapping and navigation amplifier 56.

FIG. 4 is a diagrammatic view of an exemplary three-contact patch connector 68 that may find use connecting the body patch electrodes 44 to the mapping and navigation amplifier 56 or with the junction box 16. The patch connector 68 includes two (2) device data contacts 70 for the transmission of device data to and from a memory device 14 and one (1) electrode contact 72 for the transmission of excitation signals to the patch electrodes 44.

FIG. 5 is a diagrammatic view of a connector 74 that may find use with, for example only, an ablation catheter including sensors for use with a magnetic field-based navigation system. In an exemplary embodiment, the connector 74 includes twenty-six (26) contacts 76, though not all contacts 76 are designated for visual clarity. In an exemplary embodiment, two (2) contacts may be used for device data transmission, four (4) contacts for transmission of data to and from electrodes disposed in the medical device, eleven (11) contacts for transmission of signals to and from thermocouples and thermistors disposed in the medical device, and five (5) contacts for MPS sensor signal transmission, with four (4) remaining contacts left unused.

FIG. 6 is a diagrammatic view of a connector 78 that may find use with, for example, a mapping or other diagnostic catheter with 20 electrodes (i.e., a “duodecapolar” catheter). In an exemplary embodiment, the connector 78 includes thirty-four (34) contacts 80, though not all contacts are designated for visual clarity. The connector 78 includes two (2) contacts for device data transmission, twenty (20) contacts for transmission of data to and from electrodes disposed in the medical device, and nine (9) contacts for MPS sensor signal transmission, with three (3) contacts left unused.

FIG. 7 is a diagrammatic view of a connector 82 that may find use with, for example, a mapping or other diagnostic catheter with eight (“octapolar”) or ten (“decapolar”) electrodes. In an exemplary embodiment, the connector 82 includes twenty-two (22) contacts 84, though not all contacts 84 are designated for visual clarity. The connector includes two (2) contacts for device data transmission, eight (8) or ten (10) contacts for transmission of data to and from electrodes disposed in the medical device, and five (5) contacts for MPS sensor signal transmission.

FIG. 8 is a diagrammatic view of a connector 86 that may find use with, for example, a mapping or other diagnostic catheter with four (“quadrapolar”) or six (“hexapolar”) electrodes. In exemplary embodiment, the connector 86 includes fourteen (14) contacts 88, though not all contacts 88 are designated for visual clarity. The connector 86 includes two (2) contacts for device data transmission, four (4) or six (6) contacts for transmission of data to and from electrodes disposed in the medical device, and five (5) contacts for MPS sensor signal transmission.

As noted above, data may be transmitted to or from a memory device 14 with a higher current than sensor and electrode data. As a result, it could be dangerous to the patient to whom electrodes are connected or in whom electrodes are disposed if device data signals are transmitted through an electrode signal pathway. As a result, it may be advantageous to use a connector style that isolates the device data signal pathway from the signal pathways used for electrodes and other sensors.

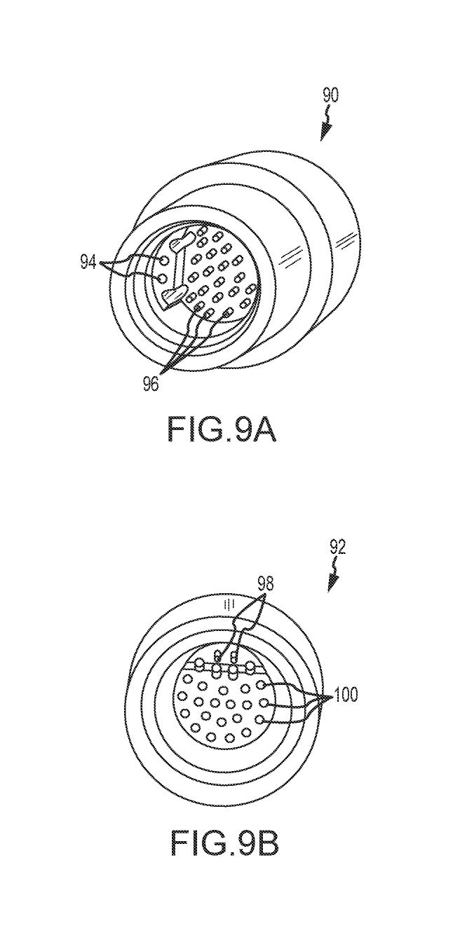

FIGS. 9A-9B are isometric views of an exemplary connector pair for electrically connecting a medical device 12 coupled with an memory device 14 to, for example, the junction box 16. FIG. 9A illustrates a receiving port 90, and FIG. 9B illustrates a complementary proximal connector 92 configured to be disposed at the proximal end of a medical device, such as the ablation catheter 12₁. The receiving port 90 may be included in an extension cable or as a port in an apparatus, such as the junction box 16. In the latter instance, the connector 92 may be included in an extension cable extending from the medical device 12 to allow for the connection with the port in the apparatus.

The connector pair 90, 92 illustrates a “hermaphroditic” connection style including both male and female components on each connector. In the illustrated embodiment, the receiving port 90 includes two (2) female ports 94 and twenty-four (24) male prongs or pins 96, though not all prongs are designated for visual clarity. The proximal connector 92 includes complementary parts—two (2) male prongs or pins 98, and twenty-four (24) female ports 100, though not all female ports 100 are designated for visual clarity. Device data may be transmitted over the 2-wire transmission pathway created by the complementary female ports 94 in the receiving port 90 and the male prongs 98 in the proximal connector 92. Other data, such as electrode and other sensor signals, may be transmitted using the other contacts 96, 100. As a result, the device data pathway is isolated from sensor signal pathways and the patient is protected from high-current device signals.

The use of memory devices 14 and sharing of data stored on those memory devices 14 detailed above provides numerous advantages over known systems. First, a single system in the EP lab—i.e., a mapping and navigation system, ablation system, recording system, or other system—can write data to memory devices associated with medical devices not associated with the particular system. For example, an ablation system can write the time of an ablation procedure to a mapping catheter. Second, unique characteristics that may vary from individual device to individual device (even within a single model) may be stored on a memory device 14 and then used by, for example only, a mapping and navigation system to optimize system performance during a medical procedure. For example, a mapping and navigation system may more accurately process data collected from electrodes if exact electrode placement and spacing on a catheter is known. Similarly, a mapping and navigation system may more accurately depict a representation of a catheter if exact catheter shaft properties are known. Third, system calibration before a medical procedure may be faster with the use of memory devices 14. Because exact device characteristics (e.g., electrode and sensor locations) are stored, those characteristics do not need to be determined during system setup. System setup may be fully automated, with each system in the lab receiving required information from the data server 18. As a result, the setup time and, thus, total amount of time for an individual procedure may be lessened. Fourth, the usage of medical devices can be monitored and restricted to, for example, ensure patient privacy and safety. The system can ensure that products are not used beyond an expiration date or for longer than an amount of time stored on an associated memory device 14, or can alert a user if a product is subject to a recall. Fifth, data can be stored on the memory devices to monitor product use. For example, a memory device 14₁ in an ablation catheter 12₁ may store the models of the devices with which the ablation catheter 12₁ is used to aid in analysis of product use trends.

It should be understood that each of an electronic controller, ECU, and data server as described above can include conventional processing apparatus known in the art, capable of executing pre-programmed instructions stored in an associated memory, all performing in accordance with the functionality described herein. To the extent that the methods described herein are embodied in software, the resulting software can be stored in an associated memory and can also constitute the means for performing such methods. Implementation of certain embodiments, where done so in software, would require no more than routine application of programming skills by one of ordinary skill in the art, in view of the foregoing enabling description. Such an electronic control unit, ECU, or data server can further be of the type having both ROM, RAM, a combination of non-volatile and volatile (modifiable) memory so that the software can be stored and yet allow storage and processing of dynamically produced data and/or signals.

Although numerous embodiments of this invention have been described above with a certain degree of particularity, those skilled in the art could make numerous alterations to the disclosed embodiments without departing from the spirit or scope of this invention. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. Additionally, the phrases “electrically connected”, “electrically coupled”, “electrical connection”, “in communication”, “for communication with”, and other variations thereof are meant to be construed broadly to encompass both wired and wireless connections and communications. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A system for sharing data among a plurality of systems in an electrophysiology laboratory, the system for sharing data comprising:
a data server configured to be electrically coupled with a memory device and with the plurality of systems, the memory device being coupled with a medical device;
wherein said data server is configured to receive device data relating to the medical device stored on the memory device, to transmit said received device data to at least one of the plurality of systems, to receive device use data from one or more of the plurality of systems, and to transmit said device use data to the memory device.

2. The system of claim 1, wherein the memory device comprises one of an electrically erasable programmable read-only memory and a radio frequency identification chip.

3. The system of claim 1, wherein said data server is configured to be electrically coupled with a plurality of memory devices, each of the plurality of memory devices coupled with a respective medical device, further wherein said data server is configured to transmit said device use data to at least two of the plurality of memory devices.

4. The system of claim 1, wherein said device data comprises device characteristic data.

5. The system of claim 4, wherein said device characteristic data comprises data relating to at least one of an electrode spacing of electrodes of the medical device, a length of at least one electrode of the medical device, a number of electrodes of the medical device, a manufacturer of the medical device, a model of the medical device, a brand of the medical device, a type of the medical device, and an expiration date of the medical device.

6. The system of claim 4, wherein said device data further comprises device use data.

7. The system of claim 1, wherein said device use data comprises data relating to at least one of a usage count of the medical device, a usage time of the medical device, and a usage timestamp.

8. The system of claim 1, wherein said data server is further configured to be electrically coupled to a network, to transmit data received from the memory device over the network, and to transmit data received from the network to the memory device.

9. The system of claim 1, wherein said data server is further configured to transmit data in an encrypted format.

10. The system of claim 1, wherein said data server is configured to receive data in an encrypted format.

11. The system of claim 10, wherein said data server is further configured to decrypt received data.

12. A system for sharing data among a plurality of systems in an electrophysiology laboratory, the system for sharing data comprising:
an apparatus configured to be electrically coupled with a plurality of medical devices, to receive device data from a plurality of memory devices respectively coupled to the plurality of medical devices, to receive sensor data from a plurality of sensors coupled to the medical devices, and to route said device data and said sensor data; and
a data server configured to receive device data respective of at least one of the memory devices from said apparatus and to transmit said received device data to one or more of the plurality of systems.

13. The system of claim 12, wherein said apparatus is further configured to receive device use data from said data server and to route said device use data at least one of the memory devices.

14. The system of claim 12, wherein one of the plurality of systems is an ablation system and said apparatus is further configured to be electrically coupled with the ablation system and to connect the ablation system to at least one of the medical devices for ablation energy to be provided from the ablation system to the at least one medical device.

15. The system of claim 14, wherein said apparatus is further configured to route device data respective of at least one of the plurality of memory devices, the at least one memory device coupled to the at least one medical device, to the ablation system.

16. The system of claim 12, wherein one of the plurality of systems is a mapping and navigation system and said apparatus is further configured to route said sensor data to the mapping and navigation system.

17. The system of claim 12, wherein said apparatus is further configured to route one or more of said device data and said sensor data over a local network.

18. A system for sharing data among a plurality of systems in an electrophysiology laboratory, the system for sharing data comprising:
a medical device;
a memory device coupled with said medical device;
a junction box; and
a data server;
wherein said junction box is configured to be coupled with said medical device, to receive device data stored on said memory device, to route said device data to said data server, and to route device use data to said memory device; and
wherein said data server is configured to receive device data from said junction box, to transmit said device data to one or more of the plurality of systems, to receive device use data from one or more of the plurality of systems, and to transmit said device use data to said junction box.

19. The system of claim 17, wherein said device data comprises device use data and device characteristic data.

20. The system of claim 17, wherein one of the plurality of systems is an ablation system and said junction box is further configured to be coupled to the ablation system and to transmit said device data to the ablation system.
